(19) United States
(12) Patent Application Publication
(10) Pub. No.: US 2004/0074410 A1
(43) Pub. Date: Apr. 22, 2004

(54) Device for removing electric charges from flat materials

(76) Inventor: Helmut Domes, Stuttgart (DE)

Correspondence Address: Richard A. Romanchik, Esq., Heidelberg Digital L.L.C., 2600 Manitou Road, Rochester, NY, 14624, US

(21) Appl. No.: 09/859,774

(22) Filed: May 17, 2001

(30) Foreign Application Priority Data
May 17, 2000 (DE) 100 23 939.0

(51) Int. Cl. B41F 1/00

(52) U.S. Cl. 101/419

(57) ABSTRACT

A device for removing electric charges from flat or printed material that is transported through a feed channel made up from grounded metal plates, particularly for printed material on the conveyor of a printer or copy machine. At least one discharging mechanism situated approximately perpendicular to the transport direction of the printed material is disposed opposite the outer surface of the metal plates turned away from the feed channel, whereby the discharging devices are situated so that they are essentially opposite each other or staggered in the transport direction of the printed material. The discharging devices are made up of either passive means and/or active devices positioned approximately perpendicular to the transport direction of the printed material across the entire width of the feed channel. The metal plates that make up the feed channel for the printed material have an opening for the active discharging mechanism in the area of each ionization tip that goes through to the feed channel, so that when the ionization strip is active, the ions generated have access to the feed channel.

### TECHNICAL FIELD

The invention concerns a device for removing electric charges from flat material, transported through a feed channel made from grounded metal plates, particularly for printed material fed on the conveyor in a printer or copy machine.

### BACKGROUND

Printed materials such as paper, transparencies, etc., are electrically charged as a result of being carried by the conveyor of the printer or copy machine. To prevent the printed papers or transparencies from sticking to each other in the output tray or from sticking to components of the conveyor that are electrically conductive, this electric charge must be removed.

### DISCLOSURE OF THE INVENTION

According to the invention, an apparatus to remove electric charges from printed materials transported through a feed channel comprises at least one grounded metal plate arranged to be in contact with the printed materials and at least one discharging mechanism disposed opposite the outer surfaces of the metal plates approximately perpendicular to the transport direction of the printed material.

According to another aspect of the invention, an apparatus to remove electric charges from printed materials transported through a feed channel comprises at least one grounded metal plate arranged to be in contact with the printed materials; at least one discharging mechanism disposed opposite the outer surface of one of the metal plates approximately perpendicular to the transport direction of the printed material; and a brush disposed beyond the metal plate in the direction of travel for passively discharging the printed materials.

The present invention can be achieved with a type of device whereby, on each of the outer surfaces of the metal plates turned away from the feed channel, at least one discharging mechanism is situated approximately perpendicular to the transport direction of the printed material, so that the discharging mechanisms may be arranged so that they are essentially opposite each other or staggered in the transport direction of the printed material. The discharging mechanisms comprise passive and/or active means, which may be situated approximately perpendicular to the transport direction of the printed material over the the feed channel. For this purpose, active discharging mechanisms with high alternating voltage ionization strips are provided, which have ionizing tips situated the same distance apart along a line approximately perpendicular to the feed channel. The inventive device is put together so that the metal plates which comprise the feed channel for the printed material have an opening into the feed channel around the ionization tips of the discharging device, so that when the ionization strips are active, the ions generated reach the feed channel, i.e., the printed material. These openings can be either round, square or rectangular.

In one embodiment, the openings consist of long slits positioned between the tongues that are formed from the metal plates. For these types of devices, an optimal removal of the electric charge on both sides of the printed material is possible.

The present invention creates a dependable device to remove electric charges from printed materials that are processed by electro-photographic copy machines or printers. This is effective in removing surface charges that are polar opposites on the top and bottom sides of printed material, so-called double layered charges.

Other features and advantages are in the description of the figures for the invention as well as in the claims.

### BRIEF DESCRIPTION OF THE DRAWINGS

FIG. 1 is an inventive device with two active discharging mechanisms, depicted schematically.

FIG. 2 is an inventive device with an active and a passive discharging mechanism, depicted schematically.

FIG. 3 is an illustration of one embodiment of the formation and arrangement of the openings for the ionization tips in the metal plates of the inventive device, depicted schematically.

FIG. 4 is an illustration of one embodiment of the arrangement of the openings, according to FIG. 3, depicted schematically.

FIG. 5 is one embodiment of a version of the formation of the openings according to FIG. 3, depicted schematically.

FIG. 6 is one embodiment of a version of the arrangement of the openings according to FIG. 5, depicted schematically.

### DETAILED DESCRIPTION

Referring now to the drawings wherein like reference numerals designate like or corresponding parts throughout different views, there is shown in an electro-photographic copy machine or printer having a feed channel 14 made up of grounded metal plates 12 and 13 opposing each other in order to transport printed materials 11. The metal plates 12 and 13 may be on the order of 1 mm steel sheets, which would delimit a 3 mm high conveyor defined by the gap between metal plates 12 and 13.

During print processing, as materials are being moved on the conveyor or the feed channel 14 of the printing machine, the printed materials 11 are charging on both sides with positive and negative electric charges, which should be removed for reasons mentioned above.

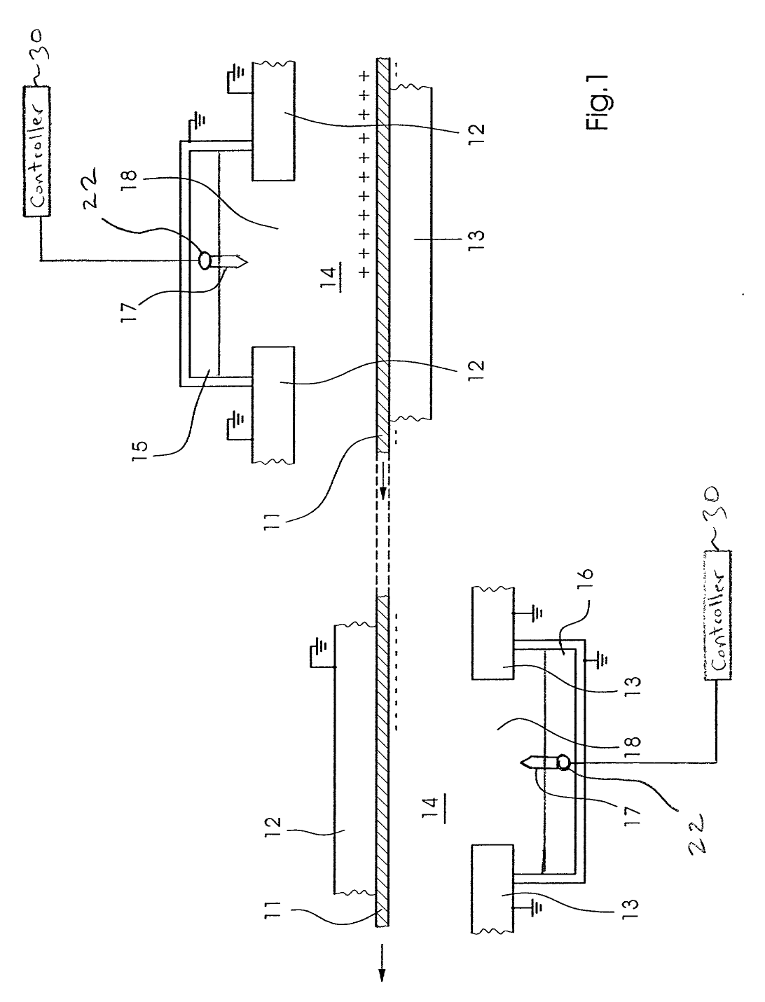

For this purpose, as shown in FIG. 1, an active discharging mechanism in the form of high alternating voltage ionization strips or strip assemblies 15 and 16 is situated opposite the outer surface of the metal plates 12 and 13. These ionization strips 15 and 16 are positioned approximately perpendicular to the transport direction of the printed material 11 and stretch over the entire width of the feed channel 14, and have ionization tips 17 situated a distance apart from one another (on the order of 10 mm) in a straight line and positioned approximately perpendicular to the feed channel 14. The tips are interconnected by a conductive strip member 22. Ionization tips are active devices, such as high alternating voltage corona discharging devices and are energized by a controller 30. The ions created from the devices are pulled from the electric field of the charge that is to be removed, and in this way the charge on the printed material is compensated or neutralized. The efficiency of the discharge is dependent on surrounding factors. Across from each ionization tip 17, there is an opening 18 in the metal plates 12 and 13, which allows the generated ions access from the ionization tip 17 to the feed channel 14 and thus to the printed material 11.

The embodiment in FIG. 1 depicts the feed channel as offset for ease of understanding in the drawing, but in most circumstances will be straight, so as to transport the printed material 11 in a straight line. The ionization strips 15 and 16 are situated one after the other (or serially) in the transport direction of the printed material 11.

Printed materials 11 that have an electric charge, are transported on the feed channel 14, and lie on the metal plate 13. The positive charge on the free surface that is turned toward or facing the ionization strip 15 is compensated by the ionization tips 17. Because of the remaining negative charge on the underside of the printed material 11, the charged surface lies upon the metal plate 12 and the negative charge is compensated by the ionization strip 16 connected in series.

Because of this arrangement, the charges on the surface of the printed material that touch the metal plate are compensated for more strongly, because of reflected charges, than those on the free upper surface, which results in a more efficient discharging of the latter.

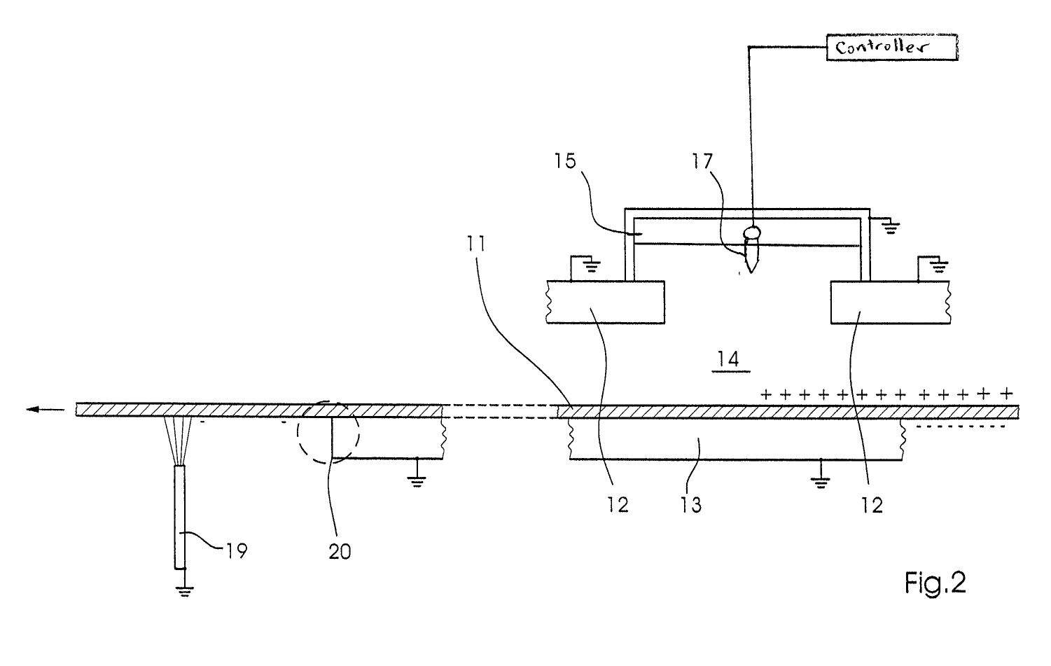

Another embodiment is shown in FIG. 2, whereby the ionization strip 16 is replaced by a passive discharging mechanism 19. Passive discharging mechanism 19 may be any of a number of electrically conductive devices which contacts the material 14. One example a brush made of conductive fibers, such as carbon fiber or high-grade steel.

Also in this embodiment, the processed printed material 11, which is electrically charged, lies on the metal plate 13 and positive charge on the top side is compensated by an ionization strip 15. After this, the printed material 11 with a discharged surface lies on the metal plate 13.

The lower metal plate 13 ends in a charge dissipation edge 20 before brush 19. This serves to further remove the negative charge from the underside of the printed material 14 in an ionization zone formed at the edge 20. Charges remaining are then removed by the brush 19.

The electric control of the ionization strips 15 and 16 must provide electric fields sufficient to neutralize the charges on the printed material and may be:

a) uncorrelated, i.e., the alternating voltage applied has any phase angle,

b) in-phase, i.e., processed with a main power supply,

c) in-opposition, wherein a potential is present between the ionization tips of both ionization strips.

The design and arrangement of the openings 18 in the metal plates 12 and 13 can be varied. One design choice might be to have as much distance as possible between the ionization tips 17 and the edge of the metal plates formed by the openings 18, upon which the ionization strips 15 and 16 rest conductively.

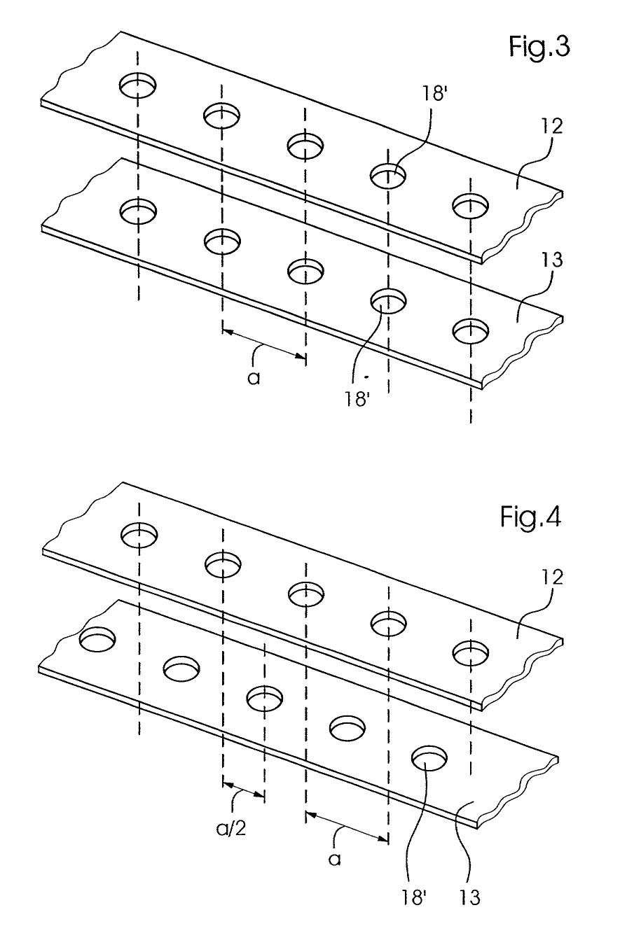

In FIG. 3 an embodiment is shown wherein the openings are depicted as round openings 18′, flush and facing each other in metal plates 12 and 13.

In FIG. 4 an embodiment is shown wherein the openings are also depicted as round openings 18′. However, they are mounted approximately perpendicular to the transport direction of the printed material, offset by distance of a/2 of the distance between two ionization tips 17 and/or of two adjacent openings.

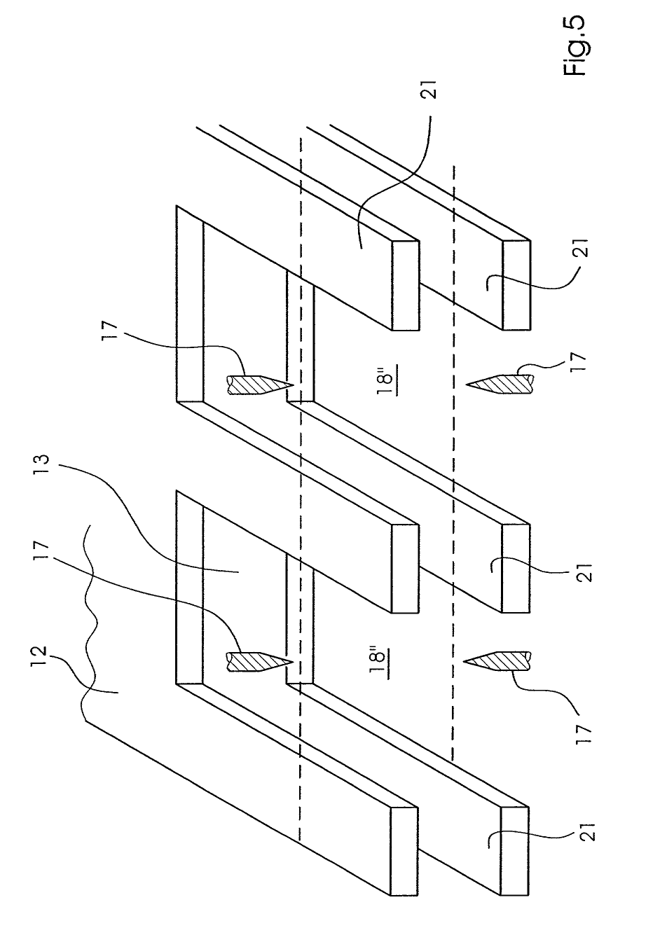

In FIG. 5 it can be seen that the openings are situated at the end of the metal plates 12 and 13 as slits 18″ between tongues 1 [sic]. The slits 18″, the tongues 21 and the ionization tips 17 are flush to each other.

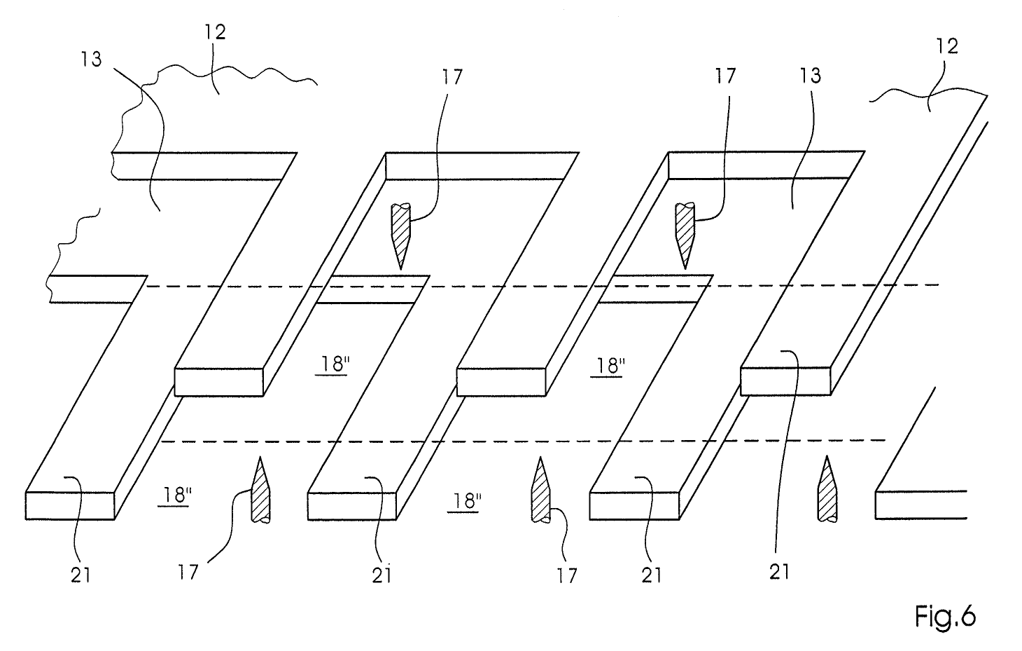

For the embodiment depicted in FIG. 6, the slits 18″ and the tongues 21 of the metal plates 12 and 13, as well as the ionization tips 17, are arranged offset by half the distance between the two adjacent ionization tips 17 and approximately perpendicular to the transport direction of printed material 11.

1. An apparatus to remove electric charges from printed materials transported through a feed channel comprising at least one grounded metal plate arranged to be in contact with the printed materials and at least one discharging mechanism disposed opposite the outer surfaces of the metal plates approximately perpendicular to the transport direction of the printed material.

2. An apparatus according to claim 1, wherein the discharging mechanism stretches over the entire width of the feed channel.

3. An apparatus according to claim 1, wherein the discharging mechanism comprises spaced apart ionization strips and ionization tips disposed between the ionization strips.

4. An apparatus according to claim 1, wherein the discharging mechanism comprises a brush which contacts the printed materials.

5. An apparatus according to claim 1, wherein the discharging mechanism comprises metal plates providing an opening to the feed channel; at least one ionization strip; at least one ionization tip; and a controller for energizing the ionization tip so that when the ionization tip is energized, ions are generated in the feed channel and reach the printed material.

6. An apparatus according to claim 5, wherein the metal plate has at least one opening for receiving the ionization tip.

7. An apparatus according to claim 6, wherein the openings are formed as long slits.

8. An apparatus according to claim 6, wherein the openings are offset from each other by half the distance between two ionization.

9. An apparatus according to claim 5, wherein the discharging mechanisms are arranged staggered in the transport direction of the printed material.

10. An apparatus to remove electric charges from printed materials transported through a feed channel comprising at least one grounded metal plate arranged to be in contact with the printed materials; at least one discharging mechanism disposed opposite the outer surface of one of the metal plates approximately perpendicular to the transport direction of the printed material; and a brush disposed beyond the metal plate in the direction of travel for passively discharging the printed materials.

11. An apparatus according to claim 10, wherein the grounded metal plate has a charge dissipation edge in the transport direction of the printed material before the brush.

12. An apparatus according to claim 6, wherein the opening is round.

13. An apparatus according to claim 6, wherein the opening is square.

14. An apparatus according to claim 6, wherein the opening is rectangular.

15. An apparatus according to claim 10, wherein the discharging mechanism stretches over the entire width of the feed channel.

16. An apparatus according to claim 10, wherein the discharging mechanism comprises spaced apart ionization strips and ionization tips disposed between the ionization strips.

17. An apparatus according to claim 10, wherein the discharging mechanism comprises a brush which contacts the printed materials.

18. An apparatus according to claim 10, wherein the discharging mechanism comprises metal plates providing an opening to the feed channel; at least one ionization strip; at least one ionization tip; and a controller for energizing the ionization tip so that when the ionization tip is energized, ions are generated in the feed channel and reach the printed material.

19. An apparatus according to claim 18, wherein the metal plate has at least one opening for receiving the ionization tip.

20. An apparatus according to claim 19, wherein the openings are formed as long slits.

21. An apparatus according to claim 19, wherein the openings are offset from each other by half the distance between two ionization.

22. An apparatus according to claim 18, wherein the discharging mechanisms are arranged staggered in the transport direction of the printed material.

23. An apparatus according to claim 19, wherein the opening is round.

24. An apparatus according to claim 19, wherein the opening is square.

25. An apparatus according to claim 19, wherein the opening is rectangular.
